(19) United States
(12) Patent Application Publication
(10) Pub. No.: US 2015/0018085 A1
(43) Pub. Date: Jan. 15, 2015

(54) FAST PICK SELECTIONS IN HISTORICAL RACING DEVICES

(71) Applicant: Richard A. Herbert, Riverside, IL (US)

(72) Inventor: Richard A. Herbert, Riverside, IL (US)

(21) Appl. No.: 14/327,800

(22) Filed: Jul. 10, 2014

Related U.S. Application Data
(60) Provisional application No. 61/844,633, filed on Jul. 10, 2013.

(51) Int. Cl. G07F 17/32

(52) U.S. Cl. CPC G07F 17/3288; G07F 17/3258
USPC 463/26; 463/25

(57) ABSTRACT

A wagering system having a wagering base with different information based upon the outcome of an event that has already taken place; a first input wagering terminal for directing input wagers to access certain of the different information; and a processor for determining whether an input wager accesses the certain information. The first input wagering terminal and processor are configured to make available to a bettor at the first input wagering terminal a first input wager option based upon pre-defined criteria through which a bettor directs an input wager to access first of the different information in the wagering base. The pre-defined criteria is derived from at least one of data relating directly or indirectly to the event or to betting activity conducted through the wagering system.

### CROSS-REFERENCE TO RELATED APPLICATIONS

This application is a non-provisional of U.S. Application No. 61/844,633 filed Jul. 10, 2013.

### BACKGROUND OF THE INVENTION

1. Field of the Invention

This invention relates to wagering devices using an Historical Racing format and, more particularly, to wagering devices capable of implementing certain bet options without the use of a random number generator.

2. Background Art

Historical Racing has been established in Arkansas and Kentucky, with acceptance in more jurisdictions anticipated. While considered legal pari-mutuel devices for betting on past races, the “play” of these devices does resemble the fixed odds slot machine playing experience. RaceTech devices (U.S. Pat. Nos. 6,358,150 and 6,152,822) and devices developed by the inventor herein (U.S. Pat. Nos. 5,888,136 and 6,152,822—hereinafter, the “Herbert patents”) may utilize a random number generator for aspects of their methodologies. More specifically, rapid bet selection is made possible through the use of random number generators.

Speed of play and bet selection are inextricably bound, as bet selection is the limiting factor in achieving sufficient speed of play to make a betting device economically feasible. Taking 20-40 seconds to bet select would doom the economics of any betting system that tries to duplicate the playing experience of a fixed odds slot machine.

Some racing jurisdictions may reject a methodology of bet selection using a random number generator. Thus, a jurisdictionally approved alternative to the use of random number generators for this purpose is required to allow the same, or comparable, speed in bet selection in those jurisdictions where random number generators are not legally feasible for use with the Historical Racing model.

### SUMMARY OF THE INVENTION

In one form, the invention is directed to a wagering system including: a wagering base consisting of different information based upon the outcome of an event that has already taken place; a first input wagering terminal for directing input wagers to access certain of the different information; and a processor for determining whether an input wager accesses the certain information, to thereby entitle a bettor making an input wager that accesses the certain of the information to a return. The first input wagering terminal and processor are configured to make available to a bettor at the first input wagering terminal a first input wager option based upon pre-defined criteria through which a bettor directs an input wager to access first of the different information in the wagering base. The pre-defined criteria is derived from at least one of: a) data relating directly or indirectly to the event; and b) data relating directly or indirectly to betting activity conducted through the wagering system.

In one form, the first input wagering terminal and processor are configured to make available a second input wager option based upon pre-defined criteria through which a bettor directs an input wager to access second of the different information in the wagering base. The pre-defined criteria is derived from at least one of: a) data relating directly or indirectly to the event; and b) data relating directly or indirectly to betting activity conducted through the wagering system.

In one form, the wagering system includes a second input wagering terminal that is the same as the first input wagering terminal.

In one form, the processor is configured to create a cumulative pool based upon the input wagers from the first and second input wagering terminals.

In one form, the first input wagering terminal and processor are configured to provide a second input wager option through which a bettor inputs a wager based upon a finishing order of at least one participant in the event that is identified and selected at the first input wagering terminal by a bettor.

In one form, the pre-defined criteria for the first input wager option is identified for a bettor at the first input wagering terminal.

In one form, the pre-defined criteria identified for a bettor at the first input wagering terminal does not directly identify any participant in the event.

### BRIEF DESCRIPTION OF THE DRAWINGS

FIG. 1 is a schematic representation of a wagering system, according to the invention; and

FIG. 2 is a flow diagram representation of a method of wagering using the system of FIG. 1.

### DETAILED DESCRIPTION OF THE PREFERRED EMBODIMENT

A number of ways to replace a random number generator for bet selection are described below, however there are many other examples possible. All described systems and variations contemplated ideally permit operating speeds comparable to random number generator use. A trifecta bet is used below to illustrate the invention.

The first example relates to a RaceTech bet selection. The disclosure of RaceTech's U.S. Pat. Nos. 6,358,150 and 6,152,888 is incorporated herein by reference. A bettor might study given race statistics in the RaceTech methodology and actually select numbers 4-7-8 (1^{st}, 2^{nd}, 3^{rd} place horses corresponding betting numbers). This might take 45-60 seconds, however, and the bettor could want to bet much more rapidly—six to eight bets per minute (typical slot machine bet frequency).

All forms of Historical Racing devices must meet a major requirement to be a legal device employed by race tracks as competitors to fixed odds slot machines. They must operate in accordance with pari-mutuel rules and regulations within the jurisdiction they operate in. The inventive methodology is fully consistent with such regulation. The pari-mutuel requirement causes these Historical Racing devices to have inherent differences from a fixed odds device and regulators at some point might not want them to employ random number generators in bet selection because of this. The inventive concept may be implemented to be both fast and easy to employ for the bettor without requiring a random number generator for bet selection.

For RaceTech bettors facing the making of a bet/input wager selection/option, they could study some race statistics supplied and actually select their exact bet numbers, for example: 4-7-8. It should be noted that a bettor is under no obligation to use the race statistics in making his/her selection. The mere availability of skillful selection is enough to avoid classification as a skill-less illegal lottery. This is analogous to conventional racing where bettors can ignore past performances and instead decide to bet their birthday numbers. They might alternatively press a trigger for a random number generator to have a random set of numbers elected for them. But, should no random number generator bet selection function be allowed, or available, the following is an option that uses various data, related directly or indirectly to a past event, to present one or any number of input wagering options set up by the system operator with pre-defined criteria.

(a) the three favorites shall comprise the betting numbers (the favorite would be the first horse, the second favorite would be the second horse, etc.);

(b) the first two favorites and the fourth favorite;

(c) the second, third, and fourth favorites;

(d) the three inside post positions;

(e) the two inside post positions and the fourth;

(f) the two inside and furthest outside post position;

(g) the two favorites and the most available inside post position;

(h) the favorite and the two most available inside posts;

(i) the second favorite and two most available inside posts;

(j) the most inside post, the favorite most available, most outside post available.

There is a near limitless set of pre-defined criteria that could be set up and chosen by the game operators to be offered to the RaceTech bettors using data directly or indirectly related to the event. Naturally, to avoid game clutter, a choice of how many and which criteria to offer must be made by the game operators. The bet options are preferably identified for the bettor at his/her terminal. In short, the bet options may allow the bettor to “randomly” bet on an outcome of an event without requiring the bettor to specifically identify or identify the participants. This potentially allows quick decisions on betting format to be made by the bettors and introduces an interesting system dynamic.

Following is an example of a RaceTech methodology race game wherein the race does not change for the individual bettor. In this very common RaceTech format, wherein a given replayed race remains in front of a bettor attempting to access the winning numbers before another player (each viewing his/her own different individual race, with the goal for each bettor being to access the winning numbers of his/her own different, individual race before the other bettors access the winning number of their own different races) does so within their respective race, it is necessary to adjust as follows to implement the invention.

All the example elements listed above (and many more) for RaceTech can be developed mathematically to each cover one and only one unique number selection for every possible bet entity. In the trifecta example, 4-7-8, a set of selection directives (algorithms) can be devised that would only select for that unique set of bet selection numbers (4-7-8) . . . e.g., 1-2-3, 1-2-4, 1-2-5, 1-2-6, 1-2-7, 1-2-8, 1-2-9, 1-3-2, 1-3-5, etc. would each have a dedicated algorithm selecting those numbers. In a nine horse race there are 9×8×7=504 distinct three number combinations. For nine horse races, 504 algorithms can be deployed whereby each algorithm would select one and only one of the 504 possible combinations. For ten horse races, 10×9×8=720 distinct three horse combinations (each three number/horse combination represents one possible bet entity), for six horse races 6×5×4=120 distinct three horse combinations. In such a manner, any race could be programmed as to the proper number of algorithms to be put into play so that when the bettor hits a single “FAST PICK” bet selector button it results in just one of the possible bet selections. The order in which each unique algorithm is used to make a unique possible bet selection can be pre-arranged beforehand and then allowed to sequence in a pre-selected order. It would be effective as long as each algorithm bet selection that does not win (access the winning numbers) has that bet's corresponding algorithm removed from the mix as play continues to a concluding winning bet by some player.

There is no need to apply such to the Herbert Methodology as this has no meaning when using that different pool rather than number betting methodology.

For Herbert Historical Racing bettors, a slightly different wagering system setup is employed. The disclosure in the Herbert Patents (U.S. Pat. Nos. 5,888,136 and 6,152,822) is incorporated herein by reference. In a preferred form, Herbert uses a value system for skillful play. A bettor is given wagering information which is constantly updated every thirty seconds or so. From this information the bettor can zone in on bets offering positive expectation and avoid bets exhibiting more extreme than expected negative expectations. In such a use of skill, the Herbert Historical Racing game avoids also being classified an illegal lottery. To use a method of bet selection in Herbert that does not use a random number generator, the following is taught as possible data for one or more input wagering options:

(a) bet the highest positive current expectation bet;

(b) bet the three highest current expectation bets;

(c) bet the progressive bet with the highest positive expectation;

(d) bet the two highest progressive bets (odds wise) that have the best return expectations above expected odds.

Also in Herbert, a large number of scenarios of bet selections can be devised. The operators would compose them using pre-defined criteria and offer an appropriate number to their bettors to be able to play quickly. They might be able to be played just as quickly as a random number generator could allow play and in both cases, RaceTech and Herbert, they could bring an interesting wrinkle to betting as some association correlations may exist between these exemplary selection criteria and high payoffs.

Returning to RaceTech, particular arrangements can be utilized depending on the particular race being bet on. For example, an option could offer the three horses with the highest lifetime earnings, or the jockeys with the three highest win percentages, or the trainers with the three highest stable earnings for the year. These factors/criteria could be combined in a near limitless number of possible offerings to be devised by the game operators with the input wager/betting options preferably being derived from the above type of data that is at least one of: a) data relating directly or indirectly to the event that has already occurred; and b) data relating directly or indirectly to betting activity conducted through the wagering system. The Herbert methodology lends itself to utilizing current betting odds to devise bet selection automation, but both are adaptable for play without the use of random number generators for bet selection. And this is in addition to the always-offered skill employment methods both games may continue to offer.

In general, the invention makes possible speed betting (such as 6-8 bets per minute) necessary for economic success which heretofore was only available with the use of a random number generator for bet selection.

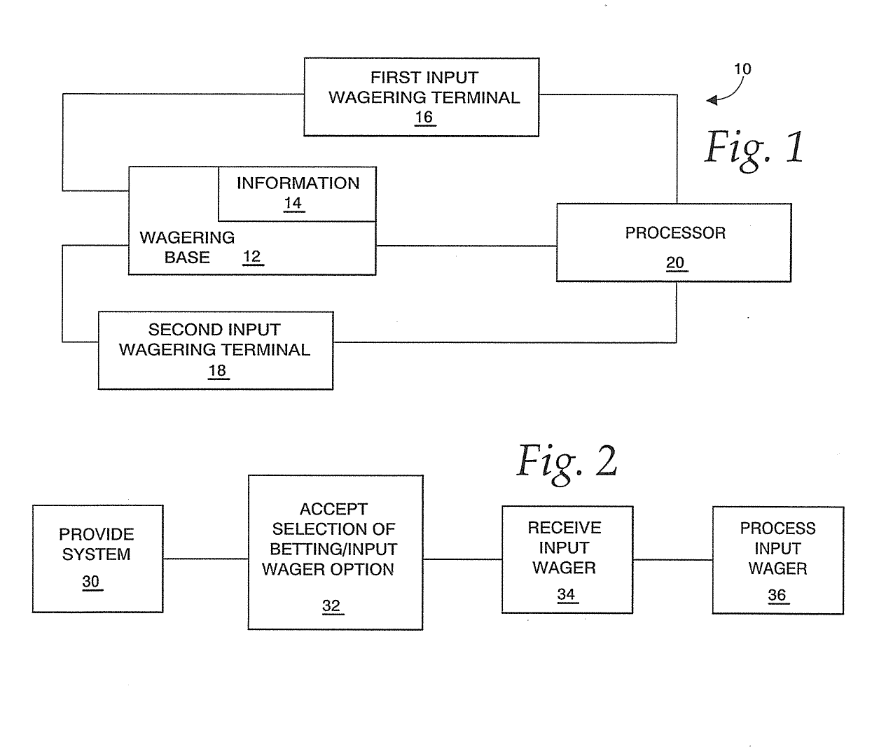

One exemplary form of a wagering system, according to the present invention, is shown schematically at 10 in FIG. 1. The schematic representation of the system 10 is intended to encompass the basic components shown therein and other system configurations, without specific limitation to the construction of each such component.

The wagering system 10 includes a wagering base 12 with different information 14 therein based upon the outcome of an event that has already taken place. The event may be a race or other type of event that can be used in a pari-mutuel type format including, but not limited to, those events described in the Herbert patents.

Separate first and second input wagering terminals 16, 18, respectively, are provided for directing input wagers to access certain of the information 14. Any number of such terminals is contemplated.

A processor 20 is configured to determine whether an input wager accesses the information 14, to thereby entitle a bettor making an input wager that accesses the certain of the information to a return.

The input wagering terminals 16, 18 and processor 20 are configured to make available a first bet/input wager option based upon pre-defined criteria through which a bettor directs an input wager to access first of the information 14 in the wagering base 12. The pre-defined criteria is pre-set by an operator and preferably derived from at least one of: a) data relating directly or indirectly to the aforementioned event; and b) data relating directly or indirectly to a betting activity conducted through the wagering system 10, as described above.

The wagering system 10 may be set up to provide any number of different input wager options with pre-defined criteria that can be derived based upon different data that is in any way related to the event, its outcome, and/or betting that is taking place, or has taken place, through the system 10.

The wagering system 10 may be set up in a format as described in the other Herbert patents, which have been incorporated herein by reference. For example, the processor 20 may be configured to create a cumulative pool based upon the input wagers from the first and second input wagering terminals 16, 18, with returns based upon total number of input wagers that access information 14 in the wagering base 12.

Preferably, the input wagering terminal(s) 16, 18 and processor 20 are configured to also maintain the basic input wager options described in the Herbert and RaceTech patents. For example, preferably, the bettor retains the ability to specifically select an outcome for the event and input a wager based upon a selected finishing order of one or more identified participants in the event, or other outcome related to the event that a bettor may specifically select. For example, a bettor may input a wager based upon the bettor's selection of participants 4-7-8. The bettor may additionally select at least one additional bet/input wager option, such as the second, third, and fourth favorites. This may be done quickly by identifying the desired bet option criteria at the bettor's terminal and inputting a wager based upon the selection(s). The displayed pre-defined criteria need not directly identify participants in the event.

With the wagering system 10, a method of wagering can be carried out as shown in flow diagram form in FIG. 2.

As shown in block 30, the system, described above and including all contemplated variations, is provided.

As shown at block 32, the bettor's selection of a bet/input wager option is accepted.

As shown at block 34, the bettor's input wager is received.

As shown at block 36, the input wager is processed and any return determined for the bettor.

The foregoing disclosure of specific embodiments is intended to be illustrative of the broad concepts comprehended by the invention.

1. A wagering system comprising:
a wagering base comprising different information based upon the outcome of an event that has already taken place;
a first input wagering terminal for directing input wagers to access certain of the different information; and
a processor for determining whether an input wager accesses the certain information to thereby entitle a bettor making an input wager that accesses the certain of the information to a return,
the first input wagering terminal and processor configured to make available to a bettor at the first input wagering terminal a first input wager option based upon pre-defined criteria through which a bettor directs an input wager to access first of the different information in the wagering base,
the pre-defined criteria derived from at least one of: a) data relating directly or indirectly to the event; and b) data relating directly or indirectly to betting activity conducted through the wagering system.

2. The wagering system according to claim 1 wherein the first input wagering terminal and processor are configured to make available a second input wager option based upon pre-defined criteria through which a bettor directs an input wager to access second of the different information in the wagering base, the pre-defined criteria derived from at least one of: a) data relating directly or indirectly to the event; and b) data relating directly or indirectly to betting activity conducted through the wagering system.

3. The wagering system according to claim 1 further comprising a second input wagering terminal that is the same as the first input wagering terminal.

4. The wagering system according to claim 3 wherein the processor is configured to create a cumulative pool based upon the input wagers from the first and second input wagering terminals.

5. The wagering system according to claim 1 wherein the first input wagering terminal and processor are configured to provide a second input wager option through which a bettor inputs a wager based upon a finishing order of at least one participant in the event that is identified and selected at the first input wagering terminal by a bettor.

6. The wagering system according to claim 1 wherein the pre-defined criteria for the first input wager option is identified for a bettor at the first input wagering terminal.

7. The wagering system according to claim 6 wherein the pre-defined criteria identified for a bettor at the first input wagering terminal does not directly identify any participant in the event.
